(19) United States
(12) Patent Application Publication
(10) Pub. No.: US 2013/0161484 A1
(43) Pub. Date: Jun. 27, 2013

(54) AUTO-FOCUSING APPARATUS AND METHOD WITH TIMING-SEQUENTIAL LIGHT SPOTS

(71) Applicants: Pin-Hao Hu, Kaohsiung City (TW); Yang-Cheng Lin, Chiayi City (TW)

(72) Inventors: Pin-Hao Hu, Kaohsiung City (TW); Yang-Cheng Lin, Chiayi City (TW)

(73) Assignee: INDUSTRIAL TECHNOLOGY RESEARCH INSTITUTE, HSINCHU (TW)

(21) Appl. No.: 13/480,819

(22) Filed: May 25, 2012

(30) Foreign Application Priority Data
Dec. 21, 2011 (TW) 100147802

(51) Int. Cl. G02B 27/40

(52) U.S. Cl. 250/201.4

(57) ABSTRACT

An auto-focusing apparatus with timing-sequential light spots includes a light source, a lens, a timing-sequential light dividing module, a focusing element and a processing module. The light source produces an incident beam. The lens collimates the incident beam that is an unsymmetrical beam relative to the lens to a collimation beam. The timing-sequential light dividing module divides the collimation beam into multiple sub-beams in timing sequence. The focusing element focuses the sub-beams to an observed object. The processing module senses energy distribution of multiple reflected beams of the observed object corresponding to the sub-beams to accordingly calculate energy centroids of the reflected beams.

This application claims the benefit of Taiwan application Ser. No. 100147802, filed Dec. 21, 2011, the disclosure of which is incorporated by reference herein in its entirety.

### TECHNICAL FIELD

The disclosed embodiments relate to an auto-focusing apparatus and method with timing-sequential light spots.

### BACKGROUND

In an automatic optical inspection (AOI) system, in order to obtain a clear image, a position of a microscopic lens needs to be constantly adjusted due to ups and downs at a surface of an observed object. Alternatively, a height of an observed object needs to be moved to locate the object in a depth range of field of the microscopic lens. The above process is referred to as auto-focusing. Along with maturity of AOI techniques, auto-focusing techniques are now prevalently applied, e.g., for panel defect repairs or integrated circuit inspections. However, when observing an object composed of multiple materials by applying a conventional active optical auto-focusing technique to a boundary environment, shapes of beams display irregular shapes as a result of different reflectivities of the different materials. Hence, the conventional active optical auto-focusing technique is unable to accurately determine defocusing and thus affecting the focusing ability, and further lowering inspection accuracy and overall manufacturing speed.

### SUMMARY

The disclosure is directed to an auto-focusing apparatus and method with timing-sequential light spots, so that a position of an observed object can be obtained by calculating centroids of reflected beams with a timing-sequential light dividing mechanism.

According to one embodiment, an auto-focusing apparatus with timing-sequential light spots is provided. The auto-focusing apparatus includes a light source, a lens, a timing-sequential light dividing module, a focusing element and a processing module. The light source produces an incident beam. The lens collimates the incident beam to a collimation beam, with the incident beam being unsymmetrical relative to the lens. The timing-sequential light dividing module divides the collimation beam into multiple sub-beams in timing sequence. The focusing element focuses the sub-beams to an observed object. The processing module senses energy distribution of multiple reflected beams of the observed object corresponding to the sub-beams and accordingly calculates energy centroids of the reflected beams.

According to another embodiment, an auto-focusing method with timing-sequential light spots is provided. The method includes steps of:

producing an incident beam by a light source; collimating the incident beam to a collimation beam by a lens, the incident beam being an unsymmetrical beam relative to the lens; dividing the collimation beam into multiple sub-beams in timing sequence by a timing-sequential light dividing module; focusing the sub-beams to an observed object by a focusing element; and sensing energy distribution of multiple reflected beams of the observed object corresponding to the sub-beams, and accordingly calculating energy centroids of the reflected beams by a processing module.

### BRIEF DESCRIPTION OF THE DRAWINGS

FIG. 1 is a schematic diagram of an auto-focusing apparatus with timing-sequential light spots according to one embodiment.

FIG. 2 is a schematic diagram of energy distribution of reflected beams corresponding to different positions of an observed object according to one embodiment.

FIG. 3 is a schematic diagram of a light dividing element according to one embodiment.

FIG. 4 is a schematic diagram of a light dividing element according to another embodiment.

FIG. 5 is a schematic diagram of an auto-focusing apparatus with timing-sequential light spots according to an alternative embodiment.

FIG. 6 is a schematic diagram of an auto-focusing apparatus with timing-sequential light spots according to another embodiment.

FIG. 7 is a schematic diagram of an auto-focusing apparatus with timing-sequential light spots according to yet another embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In an auto-focusing apparatus and method with timing-sequential light spots of the disclosure, a light source is projected to an observed object, and a position of an observed object is obtained by calculating centroids of reflected beams through a timing-sequential light dividing mechanism.

An auto-focusing apparatus with timing-sequential light spots is provided. The auto-focusing apparatus includes a light source, a lens, a timing-sequential light dividing module, a focusing element and a processing module. The light source produces an incident beam. The lens collimates the incident beam to a collimation beam, the incident beam being unsymmetrical relative to the lens. The timing-sequential light dividing module divides the collimation beam into multiple sub-beams in timing sequence. The focusing element focuses the sub-beams to an observed object. The processing module senses energy distribution of multiple reflected beams of the observed object corresponding to the sub-beams and accordingly calculates energy centroids of the reflected beams.

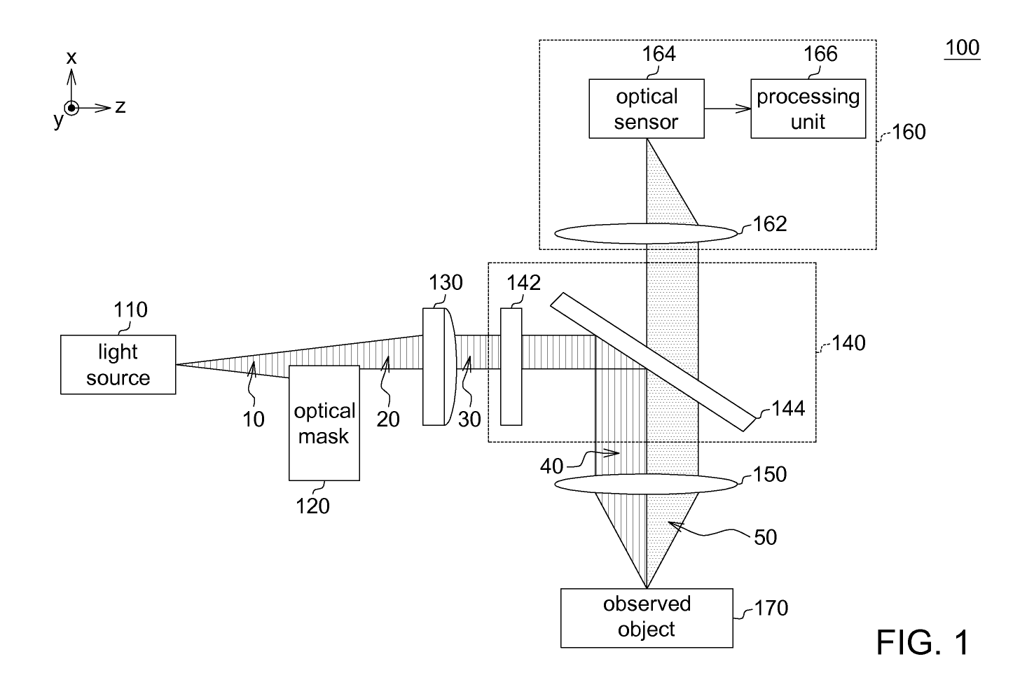

FIG. 1 shows a schematic diagram of an auto-focusing apparatus with timing-sequential light spots according to one embodiment. An auto-focusing apparatus 100 with timing-sequential light spots includes a light source 110, an optical mask 120 (optional), a lens 130, a timing-sequential light dividing module 140, a focusing element 150 and a processing module 160. The light source 110 produces an incident beam 10. The optical mask 120 masks the incident beam 10, e.g., the optical mask 120 masks the incident beam 10 along an X-direction, to reshape the incident beam 10 into a diverged semicircular beam 20. Thus, with respect to a center (i.e., an axis of a system optical path) of the lens 130, the semicircular 20 is an unsymmetrical beam. For example, the lens 130 is a cylindrical lens. In this embodiment, the lens 130 collimates the semicircular beam 20 to a uniaxial collimation beam 30, such that the collimation beam 30 is converged to a collimation beam in the X-direction and remains diverged in the Y-direction. Hence, the uniaxial collimation beam 30 appears as a long and narrow linear beam.

The timing-sequence light dividing module 140 divides the uniaxial collimation beam 30 into multiple sub-beams 40 in timing sequence. In this embodiment, the timing-sequence light dividing module 140 including a light dividing element 142 and a light dividing mirror 144 is taken as an example for explanations rather than as a limitation. The light dividing element 142 generates multiple sub-beams 40 in timing sequence. The light dividing mirror 144 projects the sub-beams 40 in timing sequence to the focusing element 150. The focusing element 150 focuses the sub-beams 40 to an observed object 170. The processing module 160 senses energy distribution of multiple reflected beams 50 of the observed object 170 corresponding to the sub-beams 40, and accordingly calculates energy centroids of the reflected beams 50.

In the above auto-focusing apparatus 100 with timing-sequential light spots, since the semicircular beam 20 with respect to the X-direction is collimated to a uniaxial collimation beam 30 after passing through the cylindrical lens 130, the uniaxial collimation beam 30 is focused on the observed object 170 after passing through the focusing element 150. Further, with respect to the Y-direction, the semicircular beam 20 maintains its innate diverging characteristic as being unaffected by the cylindrical lens 130. Thus, the uniaxial collimation beam 30 is given a certain length when being projected on the observed object 170 after passing through the focusing lens 150. Therefore, the sub-beams 40 form a long and narrow linear light spot on the observed object 170.

The processing module 160 includes a focusing lens 162, an optical sensor 164 and a processing unit 166, and it is not limited thereto. The focusing lens 162 focuses the reflected beams 50. The optical sensor 164 is disposed at a focal point of the focusing lens 162, and is for sensing energy distribution of the reflected beams 50. For example, the optical sensor 166 is a one-dimensional sensor or a two-dimensional sensor. According to the energy distribution of the reflected beams, the processing unit 166 calculates energy centroids of the reflected beams 50 to determine a defocusing distance and a defocusing direction between the observed object 170 and the focusing element 150.

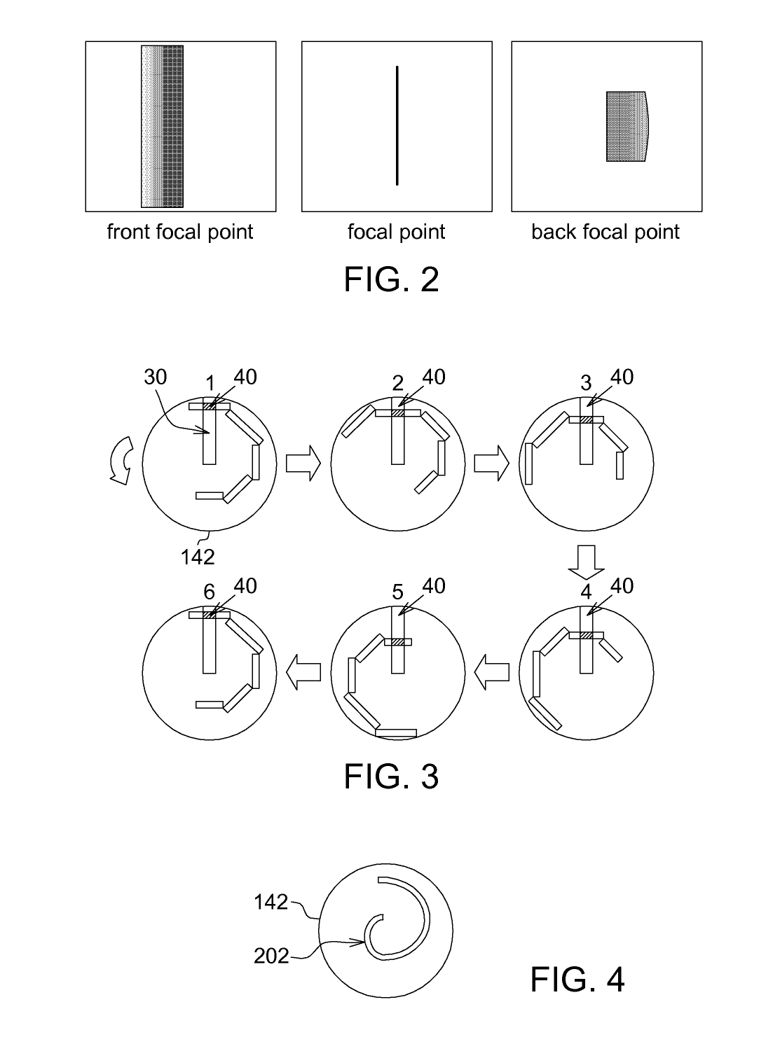

FIG. 2 shows a schematic diagram of energy distribution of corresponding reflected beams of an observed object placed at different positions of according to one embodiment. When the observed object 170 is placed at the focal point of the focusing element 150, the energy distribution of the reflected beams 50 projected on the optical sensor 164 is presented in a linear distribution. When a distance between the observed object 170 and the focusing element 150 is reduced, the energy distribution of the reflected beams 50 projected on the optical sensor 164 is widened towards the left, such that the energy centroids are located more to the left of the optical sensor 164. When the distance between the observed object 170 and the focusing element 150 is increased, the energy distribution of the reflected beams 50 projected on the optical sensor 164 is widened towards the right, such that the energy centroids are located more to the right of the optical sensor 164. Therefore, the processing unit 166 may determine the defocusing distance and the defocusing direction between the observed object 170 and the focusing element 150 according to the energy centroids.

FIG. 3 shows a schematic diagram of a light dividing element according to one embodiment. The light dividing element 142 includes a baffle having several openings. The openings are located at different distances from a rotation center of the baffle. When the light dividing element 142 is rotated, the openings sequentially encounter the uniaxial collimation beam 30. The openings are parts of the baffle allowing the uniaxial collimation beam 30 to pass through. Consequently, after passing through the rotating light dividing element 142, the uniaxial collimation beam 30 is divided into different sub-beams 40 in timing sequence.

Assume the light dividing element 142 has N number of evenly distributed openings, and rotates at a speed of a rotation period of T. At this point, an interval by which the openings encountering the uniaxial collimation beam 30 is T/N. The optical sensor 164 then senses the energy centroid at a same region at a (T1)^{th} time point, a (T1+T)^{th} time point, a (T1+2T)^{th} time point, . . . and so forth. In this embodiment, the rotation period of the light dividing element 142 is adjustable so that the positions of the energy centroids at different regions can be clearly distinguished.

Consequently, through the above timing-sequential light dividing mechanism, the optical sensor 164 can use a one-dimensional sensing array of a lower cost to replace a conventional two-dimensional sensing array to respectively calculate energy centroids of different regions, thereby significantly increasing a calculation speed for the energy centroids as well as reducing an overall cost. Furthermore, the processing unit 166 may calculate the defocusing distance and the defocusing direction according to an average of multiple energy centroids or by filtering out inappropriate energy centroids according to predetermined conditions, thus raising the focusing accuracy.

FIG. 4 shows a schematic diagram of a light dividing element according to an alternative embodiment. The light dividing element 142 is a baffle having a spiral opening 202. Different parts of the spiral opening 202 are located at different distances from the rotation center of the baffle, with the distances decreasing downwards in a clockwise direction. Assume the light dividing element 142 rotates at a speed of a rotation period T. The optical sensor 164 then senses an energy centroid at a same region at a (T1)^{th} time point, a (T1+T)^{th} time point, a (T1+2T)^{th} time point, . . . and so forth.

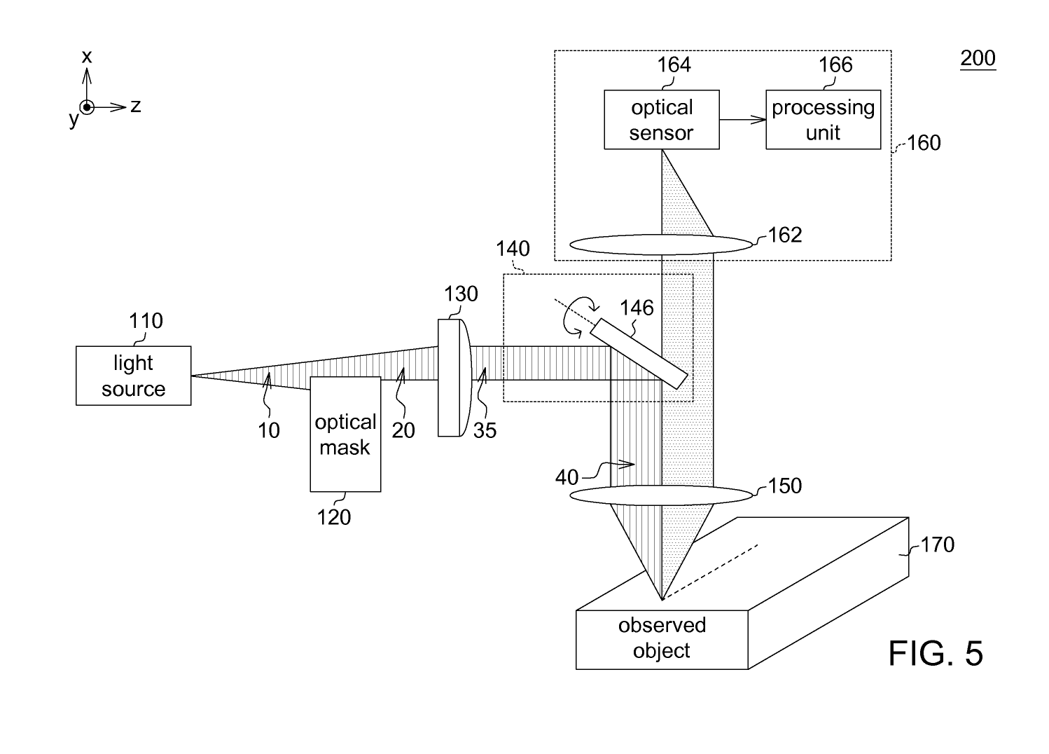

FIG. 5 shows a schematic diagram of an auto-focusing apparatus with timing-sequential light spots according to an alternative embodiment. A structure of an auto-focusing apparatus 200 with timing-sequential light spots is similar to that of the auto-focusing apparatus 100 with timing-sequential light spots, with a main difference being that the lens 130 is a focusing lens rather than a cylindrical lens. In this embodiment, the lens 130 collimates the semicircular beam 20 to a dual-axial collimation beam 35, and the semicircular beam 20 is an unsymmetrical beam with respect to a center (i.e., an axis of a system optical path) of the lens 130. Further, another difference is that the timing-sequential light dividing module 140 in this embodiment includes a one-dimensional galvanometer 146. The one-dimensional galvanometer 146 rotates along an axis to timing sequentially output the dual-axial collimation beam 35 to the sub-beams 40. The one-dimensional galvanometer 146 substantially has a rotational degree of freedom, such that the dual-axial collimation beams 40 are rotated in deviation along the Y-direction and are regarded as different sub-beams 40. After passing through the focusing element 150, the sub-beams 40 are focused at the observed object 170 to produce light spots in timing sequence.

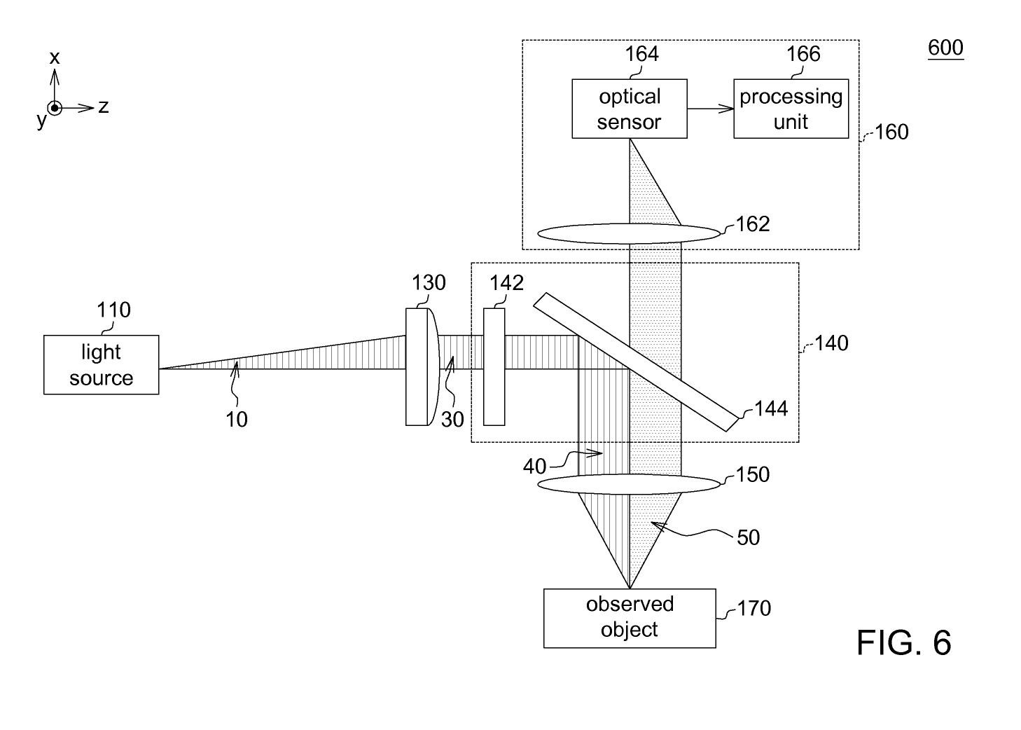

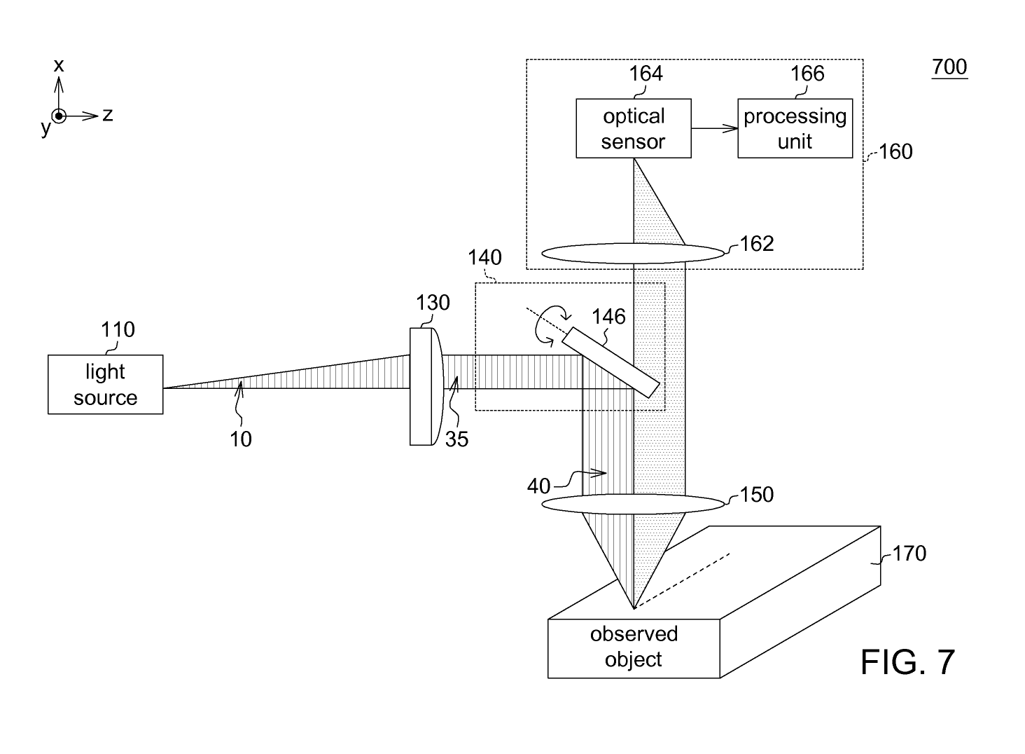

Besides, in the auto-focusing apparatuses 100 and 200 with timing sequential light spots, given that the beams emitted to the lens 130 are beams that deviate from the axis of the system optical, the optical mask 120 may be omitted as long as the beam emitted to the lens 130 deviates from the axis of the system optical path. FIG. 6 shows a schematic diagram of an auto-focusing apparatus with timing-sequential light spots according to another embodiment. FIG. 7 shows a schematic diagram of an auto-focusing apparatus with timing-sequential light spots according to yet another embodiment. A structure of an auto-focusing apparatus 600 with timing-sequential light spots is similar to that of the auto-focusing apparatus 100 with timing-sequential light spots, except that the light source 110 deviates an axis of the incident beam from the system optical path and makes the incident beam 10 directly fall at an upper part of the lens 130. A structure of an auto-focusing apparatus 700 with timing-sequential light spots is similar to that of the auto-focusing apparatus 200 with timing-sequential light spots, except that the light source 110 deviates an axis of the incident beam from the system optical path and makes the incident beam 10 directly fall at an upper part of the lens 130. Moreover, the incident beam 10 is not limited to falling at the upper part of the lens 130. Alternatively, majority of the incident beam 10 may fall at the upper part of the lens 130 while the remaining part of the incident beam 10 falls at a lower part of the lens 130. As long as a beam emitted to the lens 130 is a beam that deviates from the axis of the system optical path, the optical sensor 164 is enabled to sense a deviation of the centroids of optical energy.

An auto-focusing method with timing-sequential light spots is further provided. The method includes following steps. An incident beam is produced by a light source. The incident beam is collimated to a collimation beam by a lens. The incident beam is an unsymmetrical beam relative to the lens. The collimation beam is divided into multiple sub-beams by a timing-sequential light dividing module. The sub-beams are focused to an observed object by a focusing element. Energy distribution of multiple reflected beams of the observed object corresponding to the sub-beams is sensed, and energy centroids of the reflected beams are accordingly calculated by a processing module.

Operation principles of the above auto-focusing method with timing sequential light spots have described in detail in the above auto-focusing apparatuses 100, 200, 600 and 700 with timing sequential light spots and related descriptions, and shall be omitted herein.

The auto-focusing apparatus and method with timing sequential light spots proposed in the above embodiments utilizes a timing sequential light dividing mechanism to divide an incident beam into multiple sub-beams in timing sequence to project to an observed object, and utilizes a optical sensor to calculate optical energy centroids of different regions according to timing sequence, thus obtaining a defocusing direction and a defocusing distance of the observed object. Consequently, an issue of a conventional single beam being easily affected by a boundary environment is solved, and the focusing accuracy is raised. Furthermore, the optical sensor element can be implemented by a one-dimensional sensing array to increase a calculation speed of light spot analysis as well as to reduce a required time for focusing.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An auto-focusing apparatus with timing-sequential light spots, comprising:
a light source for producing an incident beam;
a lens for collimating the incident beam to a collimation beam, the incident beam being an unsymmetrical beam relative to the lens;
a timing-sequential light dividing module for dividing the collimation beam into a plurality of sub-beams in timing sequence;
a focusing element for focusing the sub-beams to an observed object; and
a processing module for sensing energy distribution of a plurality of reflected beams of the observed object corresponding to the sub-beams, and accordingly calculating energy centroids of the reflected beams.

2. The apparatus according to claim 1, further comprising:
an optical mask for masking the incident beam into a semicircular beam such that the lens collimates the semicircular beam to the collimation beam.

3. The apparatus according to claim 1, wherein the lens is a cylindrical lens, the collimation beam is a uniaxial collimation beam, and the timing-sequential light dividing module comprises:
a light dividing element for producing the sub-beams in timing sequence; and
a light dividing mirror for projecting the sub-beams in timing sequence to the focusing element.

4. The apparatus according to claim 3, wherein the light dividing element is a baffle having a plurality of openings, and the openings are located at different distances from a rotation center of the baffle.

5. The apparatus according to claim 4, wherein when a rotation period of the baffle is T, the processing module senses the energy centroid at a same region at a (T1)^{th} time point, a (T1+T)^{th} time point, a (T1+2T)^{th} time point, . . . and so forth.

6. The apparatus according to claim 3, wherein the light dividing element is a baffle having a spiral opening, and all parts of the spiral opening are located at different distances from a rotation center of the baffle.

7. The apparatus according to claim 6, wherein when a rotation period of the baffle is T, the processing module senses the energy centroid at a same region at a (T1)^{th} time point, a (T1+T)^{th} time point, a (T1+2T)^{th} time point, . . . and so forth.

8. The apparatus according to claim 1, wherein the lens is a focusing lens, the collimation beam is a dual-axial collimation beam, the timing-sequential light dividing module comprises a one-dimensional galvanometer, and the one-dimensional galvanometer rotates along an axis to output the uniaxial collimation beam into the sub-beams in timing sequence.

9. The apparatus according to claim 1, wherein the processing unit comprises:
a focusing lens for focusing the reflected beams;
an optical sensor, disposed at a focal point of the focusing lens, for sensing the energy distribution of the reflected beams; and
a processing unit for calculating the energy centroids of the reflected beams according to the energy distribution of the reflected beams to determine a defocusing distance and a defocusing direction between the observed object and the focusing element.

10. The apparatus according to claim 9, wherein the optical sensor is a one-dimensional sensor or a two-dimensional sensor.

11. The apparatus according to claim 10, wherein the processing unit calculates the defocusing distance and the defocusing direction according to an average of the energy centroids or by filtering the energy centroids according to a predetermined condition.

12. An auto-focusing method having timing-sequential light spots, comprising:
producing an incident beam by a light source;
collimating the incident beam to a collimation beam by a lens, the incident beam being an unsymmetrical beam relative to the lens;
dividing the collimation beam into a plurality of sub-beams in timing sequence by a timing-sequential light dividing module;
focusing the sub-beams to an observed object by a focusing element; and
sensing energy distribution of a plurality of reflected beams of the observed object corresponding to the sub-beams, and accordingly calculating energy centroids of the reflected beams by a processing module.

13. The method according to claim 12, further comprising:
masking the incident beam into a semicircular beam by an optical mask such that the lens collimates the semicircular beam to the collimation beam.

14. The method according to claim 12, the lens being a cylindrical lens, the collimation beam being a uniaxial collimation beam, the timing-sequential light-dividing module comprising a light dividing element and a light dividing mirror, the method further comprising:
producing the sub-beams in timing sequence by the light dividing element; and
projecting the sub-beams in timing sequence to the focusing element by the light dividing mirror.

15. The method according to claim 14, wherein the light dividing element is a baffle having a plurality of openings, the openings are located at different distances from a rotation center of the baffle, and the method further comprises:
rotating the baffle at a rotation period T, such that the processing module senses the energy centroid at a same region at a (T1)^{th} time point, a (T1+T)^{th} time point, a (T1+2T)^{th} time point, . . . and so forth.

16. The method according to claim 14, wherein the light dividing element is a baffle having a spiral opening, all parts of the spiral opening are located at different distances from a rotation center of the baffle, and the method further comprises:
rotating the baffle at a rotation period T, such that the processing module senses the energy centroid at a same region at a (T1)^{th} time point, a (T1+T)^{th} time point, a (T1+2T)^{th} time point, . . . and so forth.

17. The method according to claim 12, wherein the lens is a focusing lens, the collimation beam is a dual-axial collimation beam, the timing-sequential light dividing module includes a one-dimensional galvanometer, and the method further comprises:
rotating the one-dimensional galvanometer along an axis to output the uniaxial collimation beam into the sub-beams in timing sequence.

18. The method according to claim 12, wherein the processing module includes a focusing lens, an optical sensor disposed at a focal point of the focusing lens and a processing unit, and the method further comprises:
focusing the reflected beams by the focusing lens;
sensing the energy distribution of the reflected beams by the optical sensor; and
calculating the energy centroids of the reflected beams according to the energy distribution of the reflected beams to determine a defocusing distance and a defocusing direction between the observed object and the focusing element by the processing unit.

19. The method according to claim 18, further comprising:
calculating the defocusing distance and the defocusing direction according to an average of the energy centroids or by filtering the energy centroids according to a predetermined condition by the processing unit.
